(19) United States
(12) Patent Application Publication
(10) Pub. No.: US 2018/0181435 A1
(43) Pub. Date: Jun. 28, 2018

(54) CONSOLIDATION SUPPORT DEVICE AND METHOD AND NON-TRANSITORY COMPUTER-READABLE STORAGE MEDIUM

(71) Applicant: FUJITSU LIMITED, Kawasaki-shi (JP)

(72) Inventors: Naoto Ebine, Kawasaki (JP); Akinobu Takaishi, Kobe (JP); Toru Kitayama, Kobe (JP); Toshitsugu Mori, Akashi (JP); Daiki Yoshikawa, Handa (JP); Kazuyuki Sakai, Nissin (JP); Shotaro Okada, Nishinomiya (JP)

(73) Assignee: FUJITSU LIMITED, Kawasaki-shi (JP)

(21) Appl. No.: 15/852,994

(22) Filed: Dec. 22, 2017

(30) Foreign Application Priority Data
Dec. 28, 2016 (JP) 2016-256786

(51) Int. Cl. G06F 9/48

(52) U.S. Cl. CPC G06F 9/4881; G06Q 10/06312

(57) ABSTRACT

A non-transitory computer-readable storage medium storing a program that causes a computer to execute a process including retrieving business system information for a plurality of business systems configured to execute on a plurality of virtual servers, each of the plurality of business systems includes operation flows that define a plurality of operation manipulations, classifying the operation flows into operation flow types based on the operation manipulations of each of the operation flows, identifying working states of the plurality of business systems and an execution period and a change-allowed period of each of the working states based on the identified operation flow type, generating a state transition schedule for the plurality of business systems, changing, in accordance with the state transition schedule, the execution period of a first working state of a first business system included in the plurality of business systems in a range of the change-allowed period.

### CROSS-REFERENCE TO RELATED APPLICATION

This application is based upon and claims the benefit of priority of the prior Japanese Patent Application No. 2016-256786, filed on Dec. 28, 2016, the entire contents of which are incorporated herein by reference.

### FIELD

The embodiment discussed herein is related to a consolidation support device, a consolidation support method, and a non-transitory computer-readable storage medium.

### BACKGROUND

In data centers, consolidation of facilities has been promoted by using virtualization techniques for reduction in the total cost of ownership (TCO). By migrating business systems operated on physical servers to virtual servers, reduction in the number of physical servers and reduction in the cost of operation and maintenance of hardware have been implemented.

In recent years, further reduction in the TCO has been desired and there has been a movement aiming at reducing the cost of operation and maintenance taken for each virtual server by reducing the number of virtual servers. In the data center, a virtual server is prepared for each of business systems that work or for each of server types (Web server, database (DB) server, and patch server) if desired, and therefore the number of virtual servers increases. Thus, there has been a trend toward consolidation of plural business systems into one virtual server in consideration of characteristics (service time, maintenance time, batch processing time, and busyness of processing) of the business systems.

FIG. 23 is a diagram for explaining consolidation of plural business systems. As illustrated in FIG. 23, when three business systems, “profit-and-loss management system,” “QA management system,” and “purchasing system,” use virtual servers 11 different from each other, three virtual servers 11 are used. On the other hand, the number of virtual servers may be reduced by consolidating the three business systems of “profit-and-loss management system,” “QA management system,” and “purchasing system” into one virtual server 11.

There is a technique in which a primary maintenance person terminal informed of failure in a multi-vendor system instructs a maintenance company system relating to the failure to execute failure solution processing and creates and issues a report document relating to the occurrence situation and solution situation of the failure to thereby reduce trouble of a system administrator.

Furthermore, there is a technique in which, by managing operation resources information in computer system use by a use environment management information table in a centralized manner, the association between the use and the operation condition of the computer system is clarified and the reliability and manipulation performance in computer system operation management are improved.

Moreover, there is a technique in which the burden of network operation management is alleviated by displaying a route based on a link of an element existing in a failure range of an element selected according to failure occurrence as an influence range on a configuration diagram including functional sites that form the network as elements.

In addition, there is a technique in which the optimum maintenance management timing is objectively decided by comparing a breakdown restoration prospective cost calculated based on a breakdown linkage expansion obtained by Tree expansion of a breakdown event envisaged from a test event and a preventive maintenance cost for suppressing a breakdown phenomenon and determining maintenance management timing and method.

Related arts are disclosed in Japanese Laid-open Patent Publication Nos. 2004-164389, 5-334251, 2008-312023, and 2003-303014.

### SUMMARY

According to an aspect of the embodiment, a non-transitory computer-readable storage medium storing a consolidation support program that causes a computer to execute a process, the process including retrieving, from a storage device, business system information for a plurality of business systems configured to execute on a plurality of virtual servers, each of the plurality of business systems includes operation flows that define a plurality of operation manipulations that operate business system, classifying, for each of the plurality of business systems, the operation flows into operation flow types based on the operation manipulations of each of the operation flows, identifying working states of the plurality of business systems and an execution period and a change-allowed period of each of the working states based on the identified operation flow type and a start clock time and an end clock time of each of the operation flows, generating, based on the working states of the plurality of business systems and the execution period and the change-allowed period of each of the working states, a state transition schedule for the plurality of business systems, changing, in accordance with the state transition schedule, the execution period of a first working state of a first business system included in the plurality of business systems in a range of the change-allowed period to prevent an overlapping of the execution period of the first working state with the execution period of a second working state of a second business system included in the plurality of business systems, the first working state and the second working state being unable to be executed simultaneously on a single virtual server, and outputting the state transition schedule including the changed execution period of the first working state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an operation management system according to an embodiment;

FIG. 2 is a diagram illustrating one example of business system information;

FIG. 3 is a diagram illustrating one example of an operation flow;

FIG. 4 is a diagram illustrating one example of operation manipulation component information;

FIG. 5 is a diagram illustrating one example of operation flow group information;

FIG. 6 is a diagram illustrating a functional configuration of a consolidation support unit;

FIG. 7 is a diagram illustrating one example of a group information table;

FIG. 8 is a diagram illustrating four classifications of a state of a business system;

FIG. 9 is a diagram illustrating one example of a classification table;

FIG. 10 is a diagram illustrating one example of a classification result of operation flows relating to a business system that uses a batch processing result;

FIG. 11 is a diagram illustrating one example of a use information table;

FIG. 12 is a diagram illustrating one example of a change-allowed section table;

FIG. 13 is a diagram illustrating a state transition schedule and change-allowed sections;

FIG. 14 is a diagram illustrating one example of a display screen of state transition schedules that may be consolidated;

FIGS. 15A and 15B are diagrams illustrating a case in which batch processing becomes infeasible in another business system;

FIG. 16 is a flowchart illustrating a flow of consolidation support processing;

FIG. 17 is a flowchart illustrating a flow of processing of a step S1;

FIGS. 18A, 18B and 18C are a flowchart illustrating a flow of processing of a step S2;

FIG. 19 is a flowchart illustrating a flow of processing of a step S3;

FIGS. 20A and 20B are a flowchart illustrating a flow of processing of a step S4;

FIG. 21 is a flowchart illustrating a flow of processing of a step S5;

FIG. 22 is a diagram illustrating a hardware configuration of a computer that executes a consolidation support program according to the embodiment;

FIG. 23 is a diagram for explaining consolidation of plural business systems; and

FIG. 24 is a diagram illustrating an example of operation manipulations to business systems.

### DESCRIPTION OF EMBODIMENT

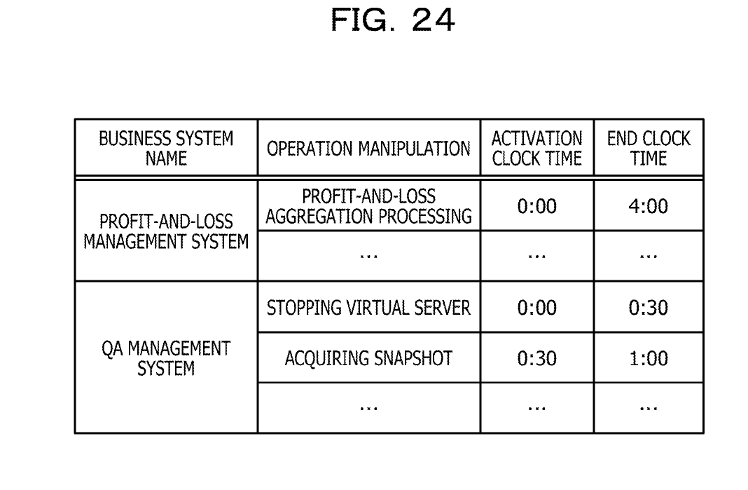

In business systems, operation manipulations are carried out for continuous service offering. FIG. 24 is a diagram illustrating an example of operation manipulations to business systems. As illustrated in FIG. 24, in the “profit-and-loss management system,” an operation manipulation relating to “profit-and-loss aggregation processing” that is activated at “0:00” and ends at “4:00” is carried out, for example. Furthermore, in the “QA management system,” an operation manipulation for “stopping virtual server” is carried out from “0:00” to “0:30,” for example.

In the operation manipulations, manipulations that affect the behavior of other business systems consolidated into the same virtual server exist, such as a reboot manipulation to an operating system (OS) and patch application. For this reason, when plural business systems are consolidated into one virtual server, it is desired that the time of the operation manipulation carried out for each of the business systems as the consolidation targets is changed to a time with which the other business systems are not affected.

For example, in the case of examining consolidation of the “profit-and-loss management system” and the “QA management system” in which the operation represented in FIG. 24 is carried out, change in the operation manipulation time is desired because the “stopping virtual server” of the “QA management system” and the “profit-and-loss aggregation processing” of the “profit-and-loss management system” are carried out in the same time zone.

However, the operation manipulations to the business systems are carried out in order to continue services offered by the business systems and the operation administrator is desired to carry out the change after checking whether the services may be offered without a problem also after the change in the time of the operation manipulation. For this reason, for change in the operation manipulation for consolidation into the virtual server, when the change depends on manpower, work for a period such as one month is carried out for understanding of the meanings of the operation manipulations to the business systems.

The embodiment discussed herein aims at supporting consolidation of plural business systems in one aspect.

An embodiment of consolidation support device, a method, and a program disclosed by the present application will be described in detail below based on the drawings. This embodiment does not limit the disclosed techniques.

### EMBODIMENT

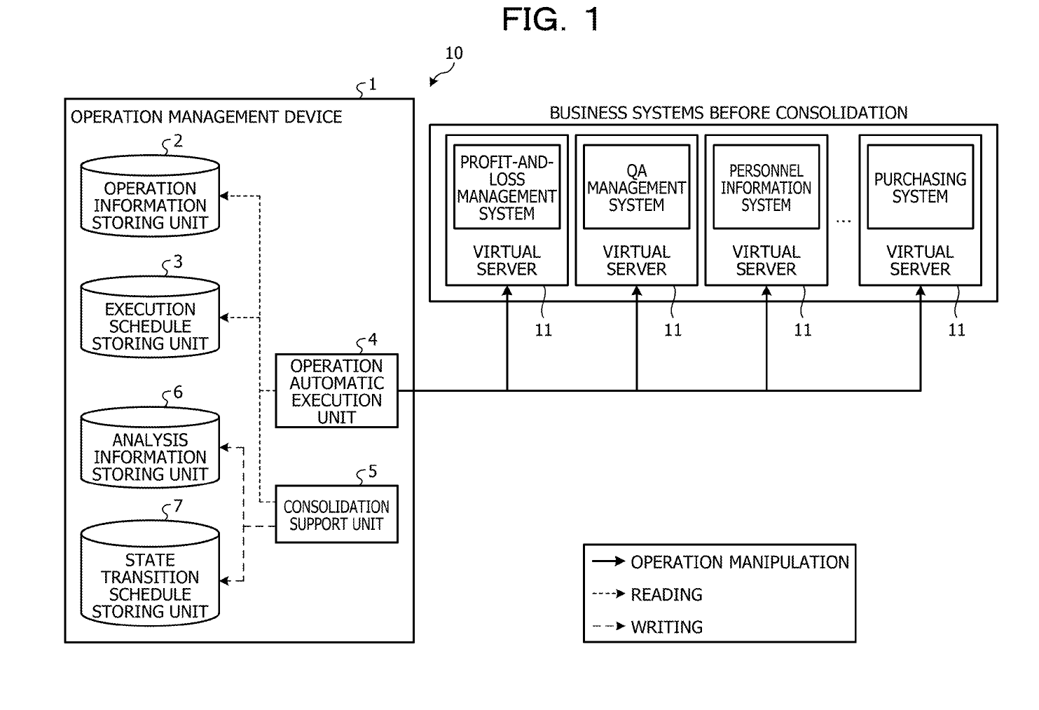

First, the configuration of an operation management system according to the embodiment will be described. FIG. 1 is a diagram illustrating a configuration of an operation management system according to the embodiment. As illustrated in FIG. 1, an operation management system 10 according to the embodiment includes an operation management device 1 and plural virtual servers 11. Business systems work in the respective virtual servers 11. Among the business systems are “profit-and-loss management system,” “QA management system,” “personnel information system,” “purchasing system,” and so forth, for example. These business systems are targets of consolidation by the operation management device 1. FIG. 1 illustrates business systems before consolidation.

The operation management device 1 is a device that manages operation of the business systems and includes an operation information storing unit 2, an execution schedule storing unit 3, an operation automatic execution unit 4, a consolidation support unit 5, an analysis information storing unit 6, and a state transition schedule storing unit 7. In FIG. 1, solid arrows represent operation manipulations. In addition, dotted arrows represent reading of data and dashed arrows represent writing of data.

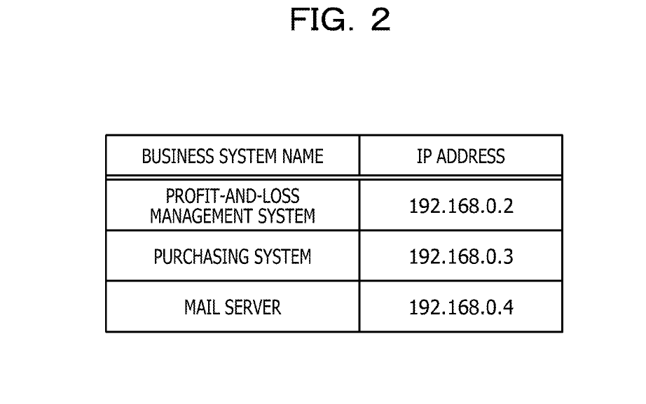

The operation information storing unit 2 stores business system information, operation flow information, operation manipulation component information, and operation flow group information. The business system information is information relating to the Internet Protocol (IP) address of the virtual server 11 on which the business system works. FIG. 2 is a diagram illustrating one example of business system information. As illustrated in FIG. 2, the business system information associates a business system name with an IP address.

The business system name is the name of the business system. The IP address is the IP address of the virtual server 11 on which the business system works. For example, the IP address of the virtual server 11 on which the “profit-and-loss management system” works is “192.168.0.2.”

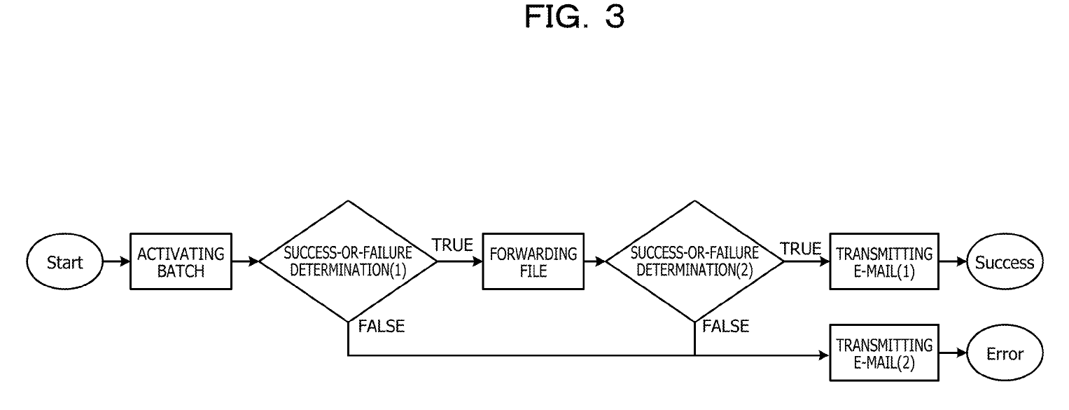

The operation flow information is information relating to an operation flow. Here, the operation flow is what is obtained by defining the procedure of a series of operation manipulations carried out to operate the business system. FIG. 3 is a diagram illustrating one example of an operation flow. FIG. 3 illustrates the operation flow of “profit-and-loss aggregation processing” in the “profit-and-loss management system.”

In FIG. 3, it is defined that batch processing is activated and then a file is forwarded if the activation succeeds and then an e-mail is transmitted (1) if the forwarding of the file succeeds. Furthermore, it is defined that batch processing is activated and then a file is forwarded if the activation succeeds and then an e-mail is transmitted (2) if the forwarding of the file does not succeed. In addition, it is defined that batch processing is activated and then an e-mail is transmitted (2) if the activation does not succeed.

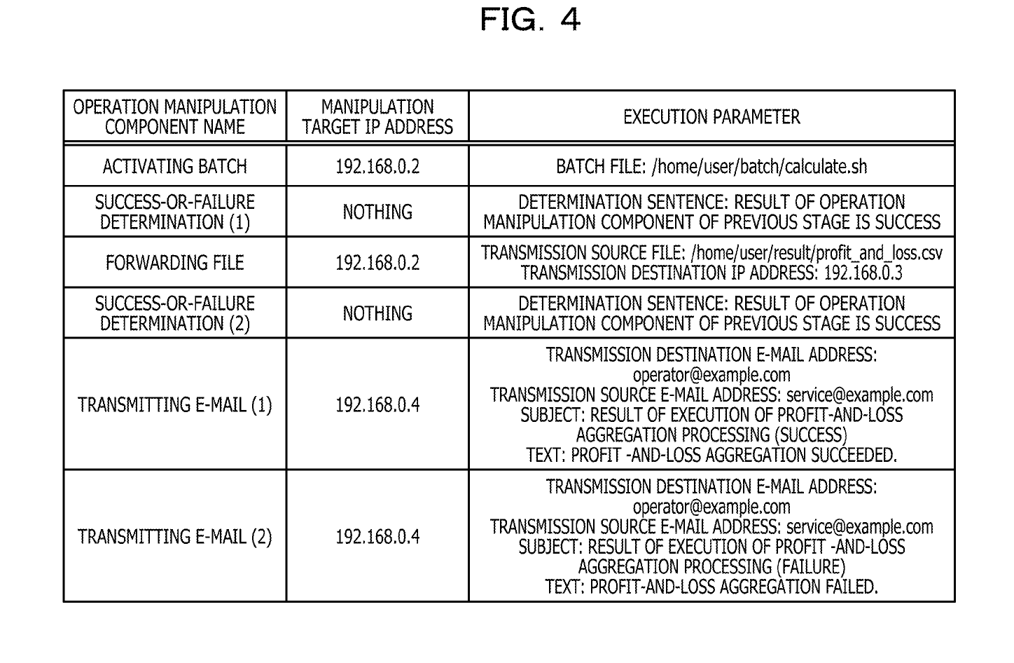

In FIG. 3, nodes of “activating batch,” “success-or-failure determination (1),” “forwarding file,” and so forth are operation manipulation components used for the definition of the operation flow. The operation manipulation component information is information relating to the operation manipulation components. FIG. 4 is a diagram illustrating one example of operation manipulation component information. As illustrated in FIG. 4, the operation manipulation component information associates an operation manipulation component name, a manipulation target IP address, and an execution parameter.

The operation manipulation component name is a name to identify the operation manipulation component. The manipulation target IP address is the IP address of the virtual server 11 on which the business system as the target of the operation manipulation works. The execution parameter is information relating to the operation manipulation.

For example, with the operation manipulation component “activating batch,” batch processing is activated in the virtual server 11 whose IP address is “192.168.0.2” by using a batch file “/home/user/batch/calculate.sh.” Furthermore, with the operation manipulation component “forwarding file,” a file “/home/user/result/profit_and_loss.csv” is transmitted to the transmission destination “192.168.0.3.”

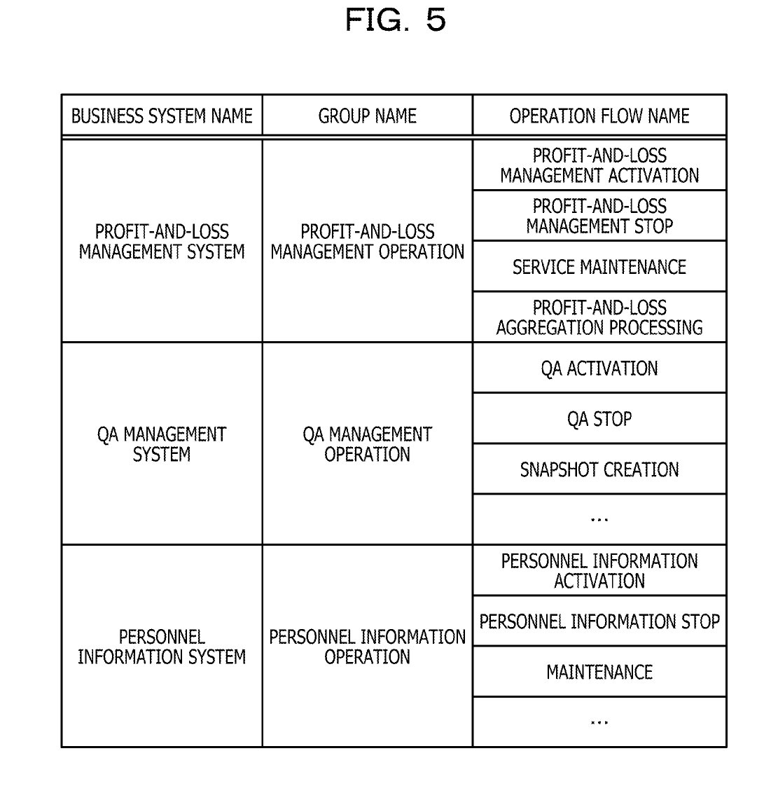

The operation flow group information is information relating to groups of operation flows. FIG. 5 is a diagram illustrating one example of operation flow group information. As illustrated in FIG. 5, the operation flow group information associates a business system name, a group name, and an operation flow name. The group name is a name to identify the group of operation flows. The operation flow name is the names of the operation flows that belong to the group.

For example, the name of the group corresponding to the “profit-and-loss management system” is “profit-and-loss management operation.” In the “profit-and-loss management operation,” operation flows “profit-and-loss management activation,” “profit-and-loss management stop,” “service maintenance,” and “profit-and-loss aggregation processing” are included.

The execution schedule storing unit 3 stores the schedule of execution of operation flows. For example, the execution schedule storing unit 3 stores the activation clock time, the end clock time, and an activation pattern regarding each operation flow. Here, as the activation pattern, there are “every day,” “Sunday,” “last day of month,” and so forth.

The operation automatic execution unit 4 carries out operation of the business system with reference to the operation information storing unit 2 and the execution schedule storing unit 3.

The consolidation support unit 5 analyzes the operation state of the business system and supports consolidation of plural business systems with reference to the operation information storing unit 2 and the execution schedule storing unit 3. The analysis information storing unit 6 stores information relating to the operation state of the business system by the consolidation support unit 5. For example, the analysis information storing unit 6 stores a group information table, a classification table, a use information table, and a change-allowed section table. The state transition schedule storing unit 7 stores the schedule of state transition of business systems that may be consolidated. Details of the consolidation support unit 5, the analysis information storing unit 6, and the state transition schedule storing unit 7 will be described in detail below.

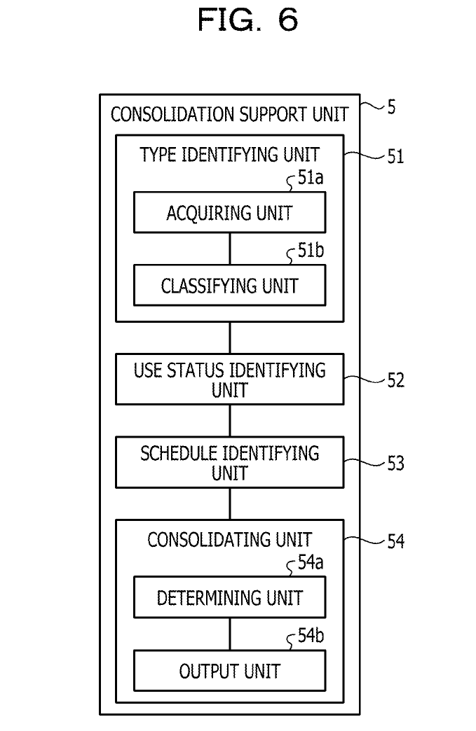

FIG. 6 is a diagram illustrating a functional configuration of a consolidation support unit. As illustrated in FIG. 6, the consolidation support unit 5 includes a type identifying unit 51, a use status identifying unit 52, a schedule identifying unit 53, and a consolidating unit 54.

The type identifying unit 51 identifies the type of the respective operation flows of business systems specified as consolidation candidates. The type identifying unit 51 includes an acquiring unit 51a and a classifying unit 51b.

The acquiring unit 51a acquires the operation flow group information corresponding to business systems specified as consolidation candidates from the operation information storing unit 2 and registers the operation flow group information in the group information table of the analysis information storing unit 6. Furthermore, the acquiring unit 51a acquires the activation clock time, the end clock time, and the activation pattern of each operation flow registered in the group information table from the execution schedule storing unit 3 and registers the activation clock time, the end clock time, and the activation pattern in the group information table.

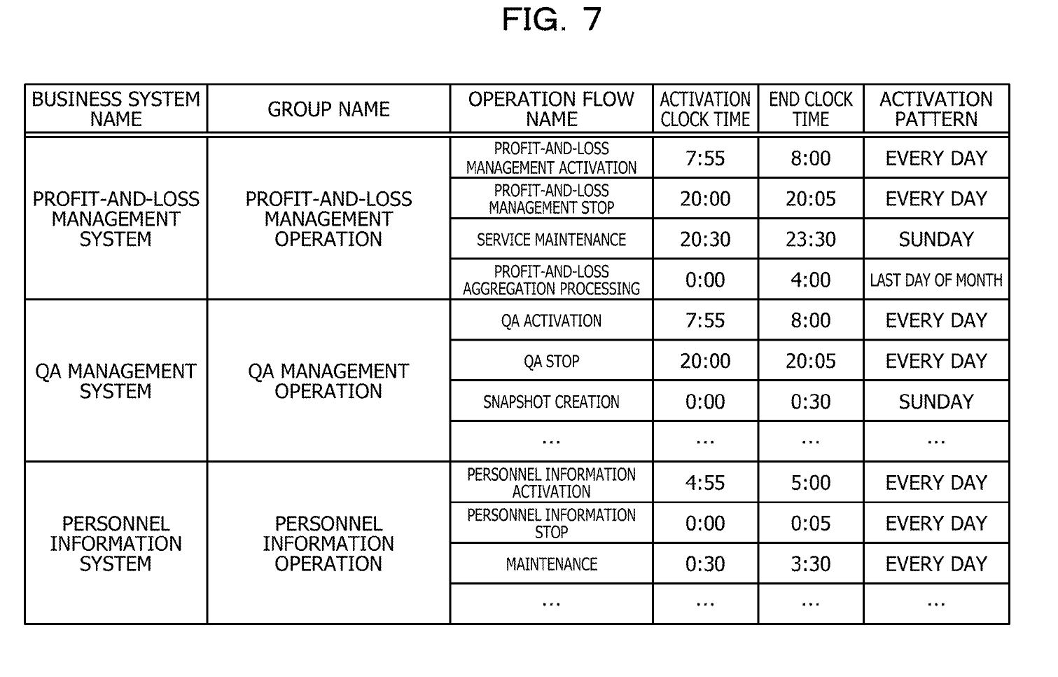

FIG. 7 is a diagram illustrating one example of a group information table. As illustrated in FIG. 7, the group information table is a table in which information obtained by adding the activation clock time, the end clock time, and the activation pattern to the operation flow group information represented in FIG. 5 is registered.

For example, the name of the group corresponding to the “profit-and-loss management system” is the “profit-and-loss management operation.” In the “profit-and-loss management operation,” the operation flow “profit-and-loss management activation” is included. The “profit-and-loss management activation” is, “every day,” activated at “7:55” and ends “8:00.”

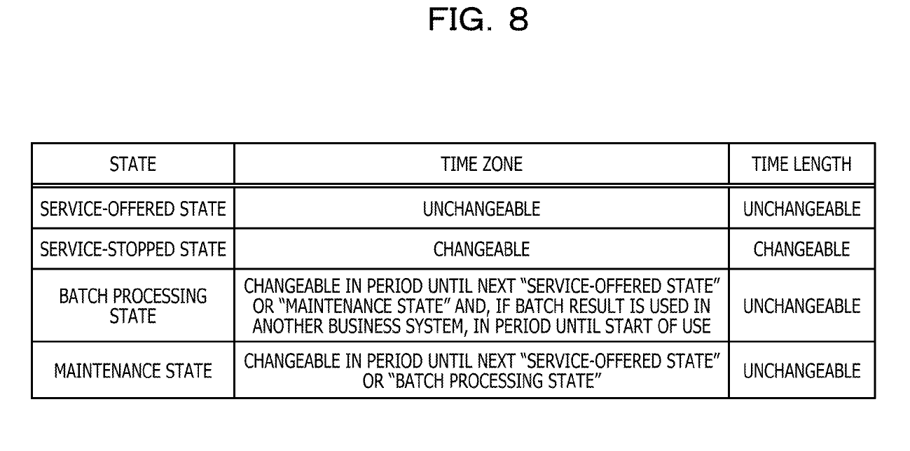

The classifying unit 51b identifies the type of the operation flow by classifying each operation flow registered in the group information table. To explain the classification of the operation flow, four classifications of the state of the business system will be described first. FIG. 8 is a diagram illustrating four classifications of a state of a business system. As illustrated in FIG. 8, as the states of the business system, there are “service-offered state,” “service-stopped state,” “batch processing state,” and “maintenance state.”

The “service-offered state” is the state in which a user of the business system may use the business system by accessing the business system by using a browser or the like, and the time zone and time length thereof are prescribed as the service level and thus are unchangeable.

The “service-stopped state” is the state in which that the present clock time is outside the service-offered time is notified when access is made from a user, and is the state in which the DB server and the batch server are in the stopped-state when the business system includes plural virtual servers 11. The “service-stopped state” does not affect the user and the operation manipulations and therefore the time zone and time length thereof may be arbitrarily changed.

The “batch processing state” corresponds to a time zone in which batch processing is executed and is the state in which that the present clock time is outside the service-offered time is notified when access is made from a user. The DB server and the batch server that form the business system are in the activated-state. If the result of the batch processing has not been transmitted to another business system, the time zone of the “batch processing state” may be changed in the period until the state of the business system becomes the “service-offered state” or the “maintenance state” next.

On the other hand, if the result of the batch processing has been transmitted to another business system, the time zone may be changed in the period until the state of the business system becomes the “service-offered state” or the “maintenance state” next and in the period until the business system of the transmission destination starts use of the result. Furthermore, the time length is not shortened in either of the above-described cases.

The “maintenance state” is the state in which patch application accompanied by reboot of the OS is carried out to the server that forms the business system or patch application to middleware is carried out. The time zone of the “maintenance state” may be changed in the period until the state of the business system becomes the “service-offered state” or the “batch processing state” next. However, transition to the “maintenance state” is not made if the business system consolidated into the same virtual server 11 is in the “service-offered state” or the “batch processing state.”

The operation flows are classified into the following four operation flows based on associating with the four states of the business state.

(1) “Service offering flow” with which the state of the business system becomes the “service-offered state” after execution of the flow

(2) “Service stopping flow” with which the state of the business system becomes the “service-stopped state” after execution of the flow

(3) “Batch processing flow” with which the state of the business system becomes the “batch processing state” in execution of the flow

(4) “Maintenance flow” with which the state of the business system becomes the “maintenance state” in execution of the flow (there are the case in which the behavior of other business systems that work on the same virtual server 11 is affected and the case in which the behavior is not affected)

The “service offering flow” switches the Web server from indicating of the “service-stopped state” to the “service-offered state.” If the “service offering flow” is determined based on whether or not a “service activation component” is present, discrimination from service activation carried out at the time of execution of maintenance is difficult. Therefore, the classifying unit 51b classifies, as the “service offering flow,” an operation flow including processing of changing the distribution destination of access to the Web server to the Web server of the business system in processing executed in the operation flow.

The determination of the processing of changing the distribution destination to the Web server of the business system is carried out based on whether the operation flow executes any of the following kinds of processing.

(1) “Replacing text string of file” exists in the operation manipulation components that form the operation flow and the operation flow switches the description of the configuration file of the Web server from indicating of the “maintenance state” to the “service-offered state.”

(2) “Switching of domain name system (DNS)” exists in the operation manipulation components that form the operation flow. Furthermore, the operation flow switches the IP address associated with the domain name of the business system from the IP address of the maintenance server to the IP address of the Web server of the business system.

(3) “Switching of load balancer” exists in the operation manipulation components that form the operation flow and the operation flow switches the response setting to the load balancer from indicating of the “maintenance state” to the Web server of the business system.

The classifying unit 51b classifies, as the “service stopping flow,” an operation flow including processing of changing the distribution destination of access to the Web server from the Web server of the business system in processing executed in the operation flow.

The determination of the processing of changing the distribution destination from the Web server of the business system is carried out based on whether the operation flow executes any of the following kinds of processing.

(1) “Replacing text string of file” exists in the operation manipulation components that form the operation flow and the operation flow switches the description of the configuration file of the Web server from indicating of the “maintenance state” to the “service-stopped state.”

(2) “Switching of DNS” exists in the operation manipulation components that form the operation flow and the operation flow switches the IP address associated with the domain name of the business system from the IP address of the Web server of the business system to the IP address of the maintenance server.

(3) “Switching of load balancer” exists in the operation manipulation components that form the operation flow and the operation flow switches the response setting to the load balancer from the Web server of the business system to indicating of the “maintenance state.”

The classifying unit 51b classifies an operation flow as the “batch processing flow” if the operation flow applies to both of the following conditions. (1) The state before execution of the flow is the “service-stopped state.”

(2) “Activating batch” exists in the operation manipulation components that form the operation flow.

The classifying unit 51b classifies an operation flow as the “maintenance flow” if the operation flow applies to both of the following conditions. (1) The state before execution of the flow is the “service-stopped state.”

(2) “Applying correction patch of OS,” “applying correction patch of middleware,” “rebooting virtual server,” or “stopping virtual server” exists in the components that form the operation flow.

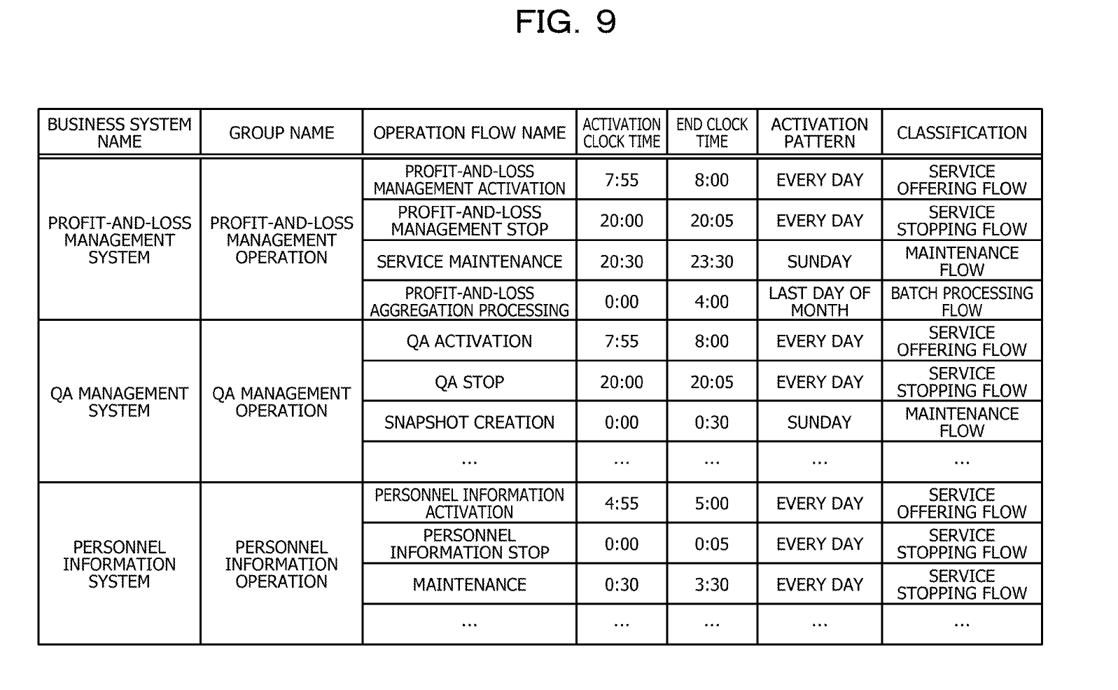

The classifying unit 51b registers the classification result of the operation flow in the classification table of the analysis information storing unit 6. FIG. 9 is a diagram illustrating one example of a classification table. As illustrated in FIG. 9, the classification table is a table obtained by adding the classification of the operation flow to the group information table illustrated in FIG. 7. For example, as illustrated in FIG. 4, “activating batch” exists as an operation manipulation component in the operation flow “profit-and-loss aggregation processing.” Thus, the “profit-and-loss aggregation processing” is classified as the “batch processing flow” when being executed in the “service-stopped state.”

The use status identifying unit 52 identifies the case in which the batch processing result of the operation flow classified as the batch processing flow is used in another operation flow with the following procedure.

(1) The use status identifying unit 52 extracts information on the operation manipulation component “forwarding file” from the operation manipulation component information in the batch processing flow. If the information on the operation manipulation component “forwarding file” does not exist, the use status identifying unit 52 ends the processing.

(2) The use status identifying unit 52 acquires the transmission destination IP address of “forwarding file” from the operation manipulation component information. For example, “192.168.0.3” is acquired as the transmission destination IP address of the file from the operation manipulation component information of the batch processing flow “profit-and-loss aggregation processing” represented in FIG. 4.

(3) The use status identifying unit 52 extracts the business system corresponding to the transmission destination IP address from the business system information. For example, the business system corresponding to “192.168.0.3” acquired as the transmission destination IP address of the file is the “purchasing system” as represented in FIG. 2.

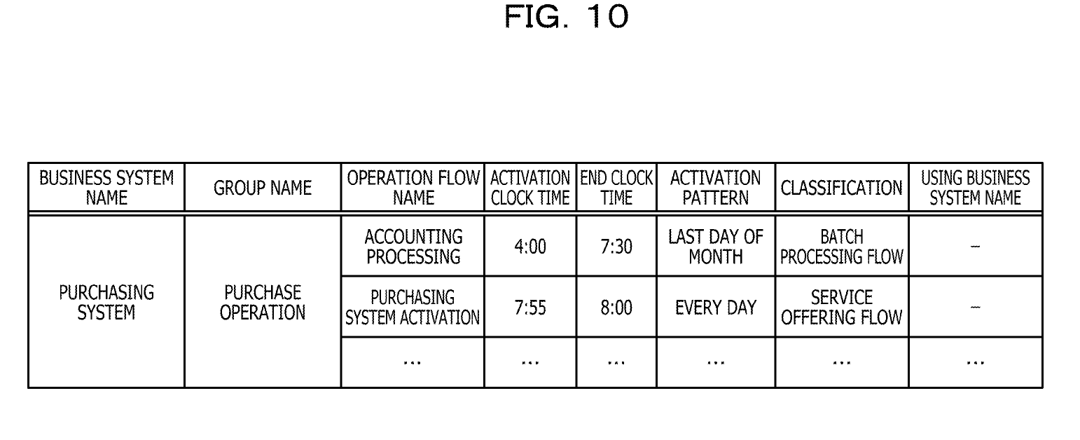

(4) The use status identifying unit 52 acquires the group of operation flows of the business system extracted in (3) and classifies the acquired operation flows. FIG. 10 is a diagram illustrating one example of a classification result of operation flows relating to a business system that uses a batch processing result. As illustrated in FIG. 10, among the operation flows relating to the “purchasing system” are “accounting processing,” “purchasing system activation,” and so forth, and the “accounting processing” is classified as the “batch processing flow.” However, in this example, the business system that uses the batch processing result of the “accounting processing” does not exist.

(5) The use status identifying unit 52 extracts an operation flow including a transmission file name in the batch processing flow included in the operation flows acquired in (4). If the operation flow including a transmission file name does not exist, the use status identifying unit 52 ends the processing.

(6) The use status identifying unit 52 registers the business system extracted in (3) in a using business system name of the use information table of the analysis information storing unit 6 and registers the operation flow extracted in (5) in a using flow name of the use information table.

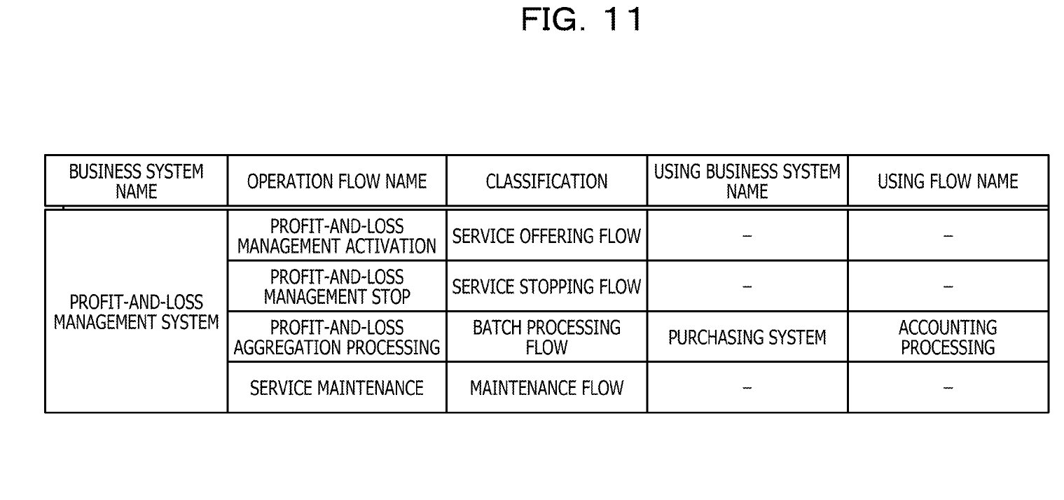

FIG. 11 is a diagram illustrating one example of a use information table. As illustrated in FIG. 11, the use information table associates the business system name, the operation flow name, the classification, the using business system name, and the using flow name. The using business system name is the name of the business system that uses the batch processing result. The using flow name is the name of the batch processing flow that uses the batch processing result. In FIG. 11, the “accounting processing” of the “purchasing system” that uses the batch processing result of the “profit-and-loss aggregation processing” is registered.

(7) The use status identifying unit 52 executes the identification processing from (1) also regarding the using flow similarly. Because the business system that uses the batch processing result of the “accounting processing” does not exist as represented in FIG. 10, the chain of use of the batch processing result beginning with the “profit-and-loss aggregation processing” ends as “profit-and-loss aggregation processing”-“accounting processing.”

The schedule identifying unit 53 identifies the state transition schedule of the business systems based on the classification result of the operation flows and the activation clock time and end clock time of the operation flows. Then, the schedule identifying unit 53 identifies the change-allowed section of the time zone regarding the “service-stopped state,” the “batch processing state,” and the “maintenance state,” whose time zone may be changed.

For example, the schedule identifying unit 53 identifies the state transition schedule of the business systems with the following procedure regarding each operation date.

(1) The schedule identifying unit 53 deems the state from the activation clock time of the “service offering flow” to the end clock time of the next “service stopping flow” as the “service-offered state.”

(2) The schedule identifying unit 53 deems the state from the activation clock time to the end clock time of the “batch processing flow” as the “batch processing state.”

(3) The schedule identifying unit 53 deems the state from the activation clock time to the end clock time of the “maintenance flow” as the “maintenance state.”

(4) The schedule identifying unit 53 deems the state of the time that does not apply to (1) to (3) as the “service-stopped state.”

Then, the schedule identifying unit 53 identifies the change-allowed section of the time zone with the following procedure. (1) If another transition to the state whose time zone is changeable does not exist before the state whose time zone is changeable, the schedule identifying unit 53 employs the end clock time of the “service-offered state” as the start-possible clock time of the state whose time zone is changeable. Furthermore, if another transition to the state whose time zone is changeable exists before the state whose time zone is changeable, the schedule identifying unit 53 employs the end clock time in the case in which all of the state is carried out at the earliest time as the start-possible clock time of the state whose time zone is changeable.

(2) If another transition to the state whose time zone is changeable does not exist after the state whose time zone is changeable, the schedule identifying unit 53 employs the start clock time of the “service-offered state” as the end-possible clock time of the state whose time zone is changeable. Furthermore, if another transition to the state whose time zone is changeable exists after the state whose time zone is changeable, the schedule identifying unit 53 employs the start clock time in the case in which all of the state is carried out at the latest time as the end-possible clock time of the state whose time zone is changeable.

Furthermore, if the batch processing result of an operation flow classified as the “batch processing flow” is used in another operation flow, the schedule identifying unit 53 identifies the change-allowed section of the time zone based on the time zone of batch processing in the other operation flow.

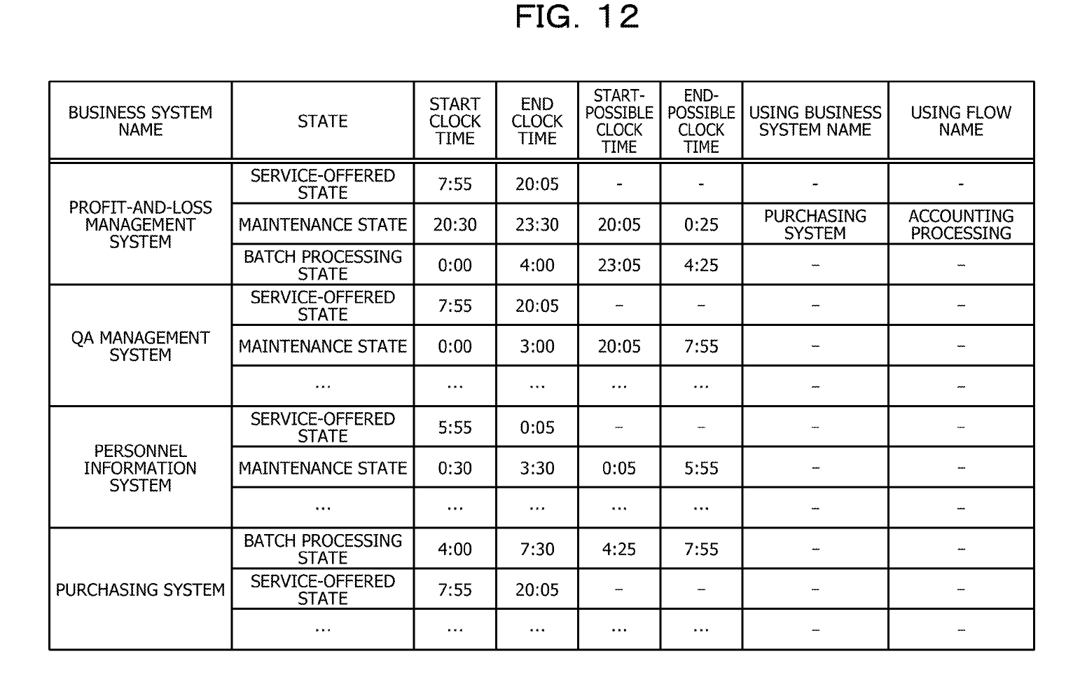

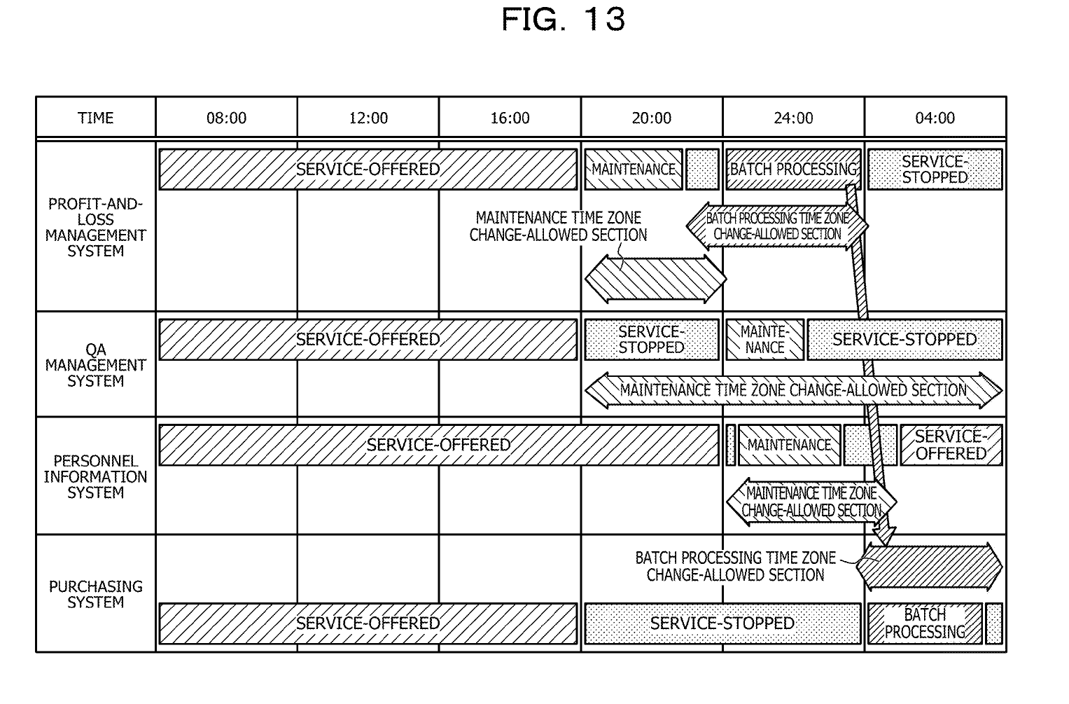

Then, regarding the “batch processing state” and the “maintenance state,” the schedule identifying unit 53 registers the start-possible clock time and the end-possible clock time in the change-allowed section table of the analysis information storing unit 6. FIG. 12 is a diagram illustrating one example of a change-allowed section table and FIG. 13 is a diagram illustrating a state transition schedule and change-allowed sections.

As illustrated in FIG. 12, the change-allowed section table associates the start clock time, the end clock time, the start-possible clock time, the end-possible clock time, the using business system name, and the using flow name regarding the “batch processing state” and the “maintenance state.”

For example, as represented in FIG. 12 and FIG. 13, the present start clock time of the “maintenance state” of the “profit-and-loss management system” is “20:30.” However, the “maintenance state” may be started from “20:05.” Furthermore, the present end clock time of the “maintenance state” of the “profit-and-loss management system” is “23:30.” However, it suffices for the “maintenance state” to end by “0:25.”

Here, the batch processing of the “profit-and-loss management system” is desired to end by “04:25” in terms of the relationship with the batch processing of the “purchasing system” and thus is desired to start by “0:25.” Therefore, the “maintenance state” of the “profit-and-loss management system” is desired to end by “0:25.”

The consolidating unit 54 determines whether or not consolidation of plural business systems specified as consolidation candidates is possible based on the state transition schedule and the change-allowed sections of the business systems. If the consolidation is possible, the consolidating unit 54 displays the state transition schedule of the business systems that may be consolidated on a screen. The consolidating unit 54 includes a determining unit 54a and an output unit 54b.

With the following procedure, the determining unit 54a determines whether or not consolidation of plural business systems specified as consolidation candidates is possible and creates the state transition schedule of the business systems that may be consolidated if the consolidation is possible.

(1) The determining unit 54a selects one of the business systems specified as the consolidation candidates and deems the selected business system as a consolidation candidate group.

(2) The determining unit 54a compares the state transition schedules of business system A that is not included in the consolidation candidate group and the business system included in the consolidation candidate group, and adds business system A to the consolidation candidate group if any of the following conditions is satisfied.

(a) Overlapping of the time zone does not occur between the “maintenance state” and the “batch processing state” and between the “maintenance state” and the “service-offered state” regarding the state of all business systems.

(b) Overlapping of the time zone does not occur between the “maintenance state” and the “batch processing state” and between the “maintenance state” and the “service-offered state” due to changing the time zone of the “maintenance state” regarding the time zone in which a certain business system becomes the “maintenance state.”

(c) Overlapping does not occur between the “maintenance state” and the “batch processing state” and between the “maintenance state” and the “service-offered state” due to changing the time zone of the state of another business system.

(3) The determining unit 54a carries out (1) and (2) regarding all combinations of the consolidation candidates. Then, if a consolidation candidate group to which plural consolidation candidates belong exists, the determining unit 54a determines that the consolidation is possible, and stores the state transition schedule of the plural consolidation candidates in the state transition schedule storing unit 7. On the other hand, if a consolidation candidate group to which plural consolidation candidates belong does not exist, the determining unit 54a determines that the consolidation is not possible.

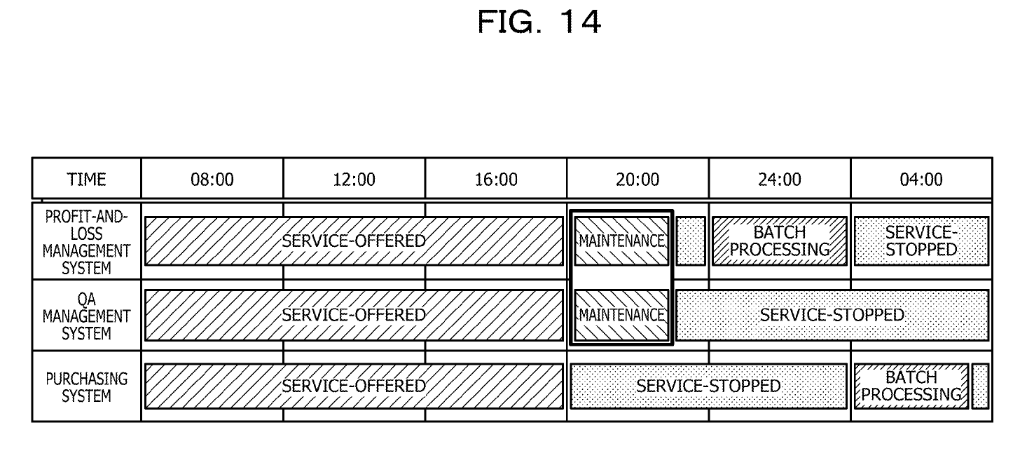

The output unit 54b displays the state transition schedules that may be consolidated on the screen regarding all consolidation candidate groups. FIG. 14 is a diagram illustrating one example of a display screen of state transition schedules that may be consolidated. Compared with FIG. 13, in FIG. 14, the overlapping between the “batch processing state” of the “profit-and-loss management system” and the “maintenance state” of the “QA management system” is resolved by changing the start clock time of the “maintenance state” of the “QA management system” from “0:00” to “20:05.”

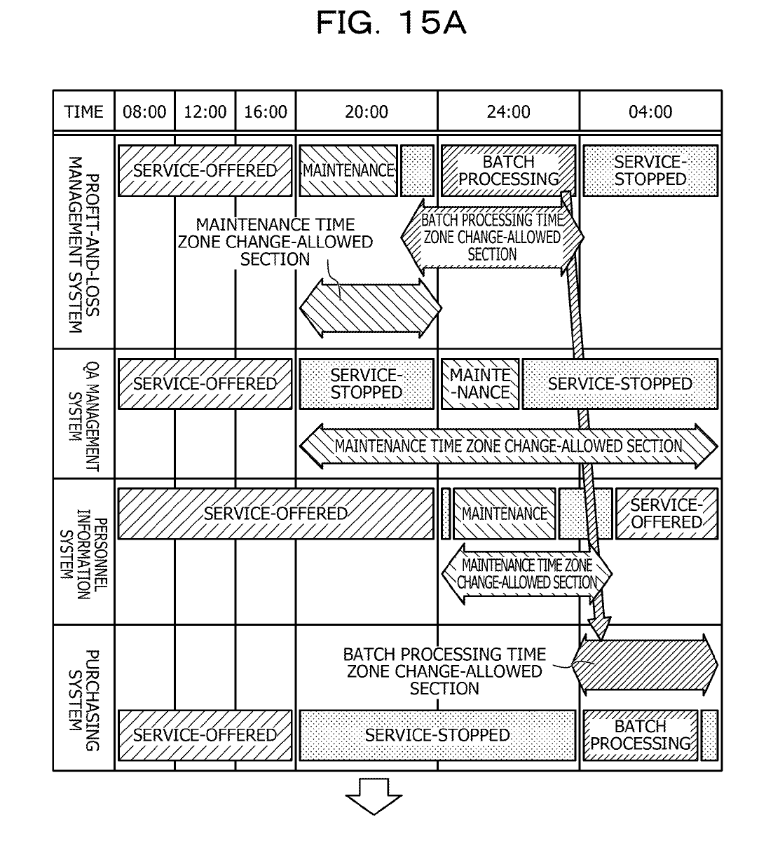

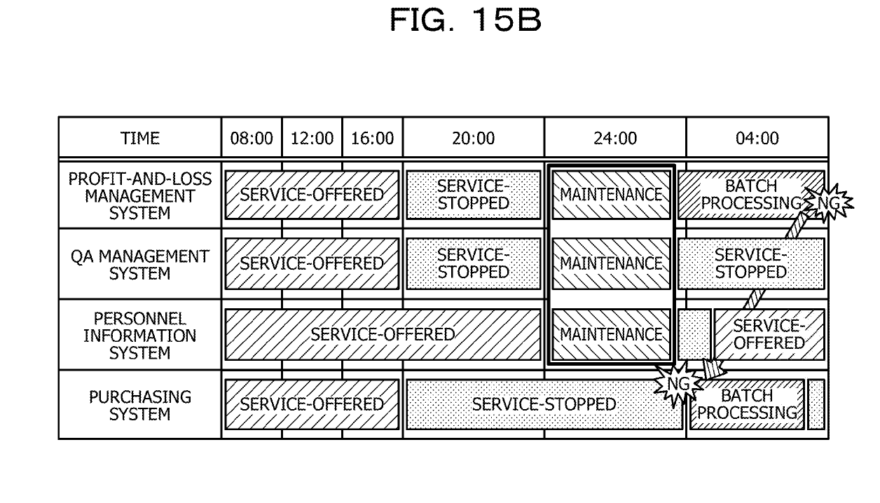

FIGS. 15A and 15B are diagrams illustrating a case in which batch processing becomes infeasible in another business system. Compared with FIG. 14, the “personnel information system” is added as a consolidation candidate in FIGS. 15A and 15B. As represented in FIG. 12, the “personnel information system” is in the “service-offered state” from “5:55” to “0:05.” Thus, the start clock time of the “maintenance state” of the “profit-and-loss management system” and the “QA management system” is changed to “0:05” and the end clock time is changed to “3:05.” However, in this case, the “purchasing system” is incapable of using the batch processing result of the “profit-and-loss management system.” Therefore, the determining unit 54a determines that the consolidation of the “profit-and-loss management system,” the “QA management system,” the “personnel information system,” and the “purchasing system” is not possible.

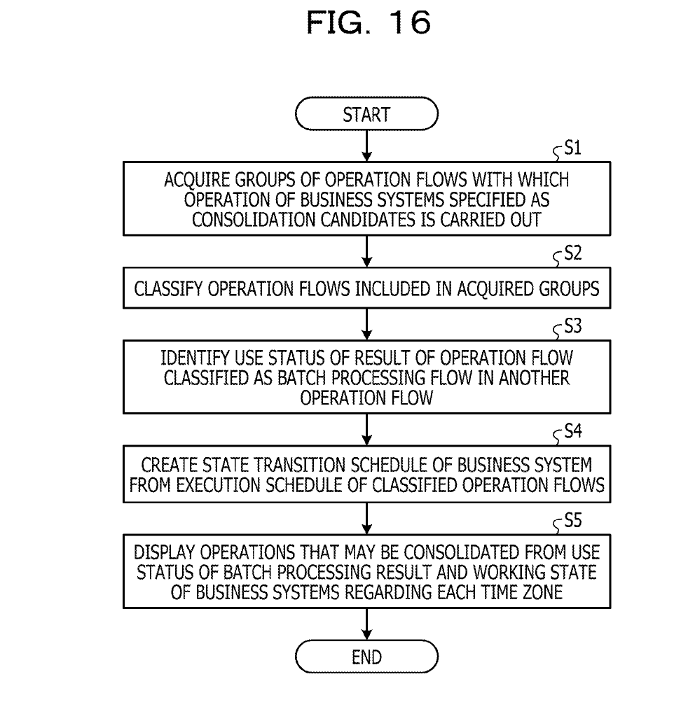

Next, the flow of consolidation support processing will be described. FIG. 16 is a flowchart illustrating a flow of consolidation support processing. As illustrated in FIG. 16, the consolidation support unit 5 acquires groups of operation flows with which operation of business systems specified as consolidation candidates is carried out (step S1) and classifies the operation flows included in the acquired groups (step S2).

Then, the consolidation support unit 5 identifies the use status of the result of the operation flow classified as the batch processing flow in another operation flow (step S3) and creates the state transition schedule of the business systems from the execution schedule of the classified operation flows (step S4). Then, the consolidation support unit 5 displays operations that may be consolidated from the use status of the batch processing result and the working state of the business systems regarding each time zone (step S5).

As above, the consolidation support unit 5 may support consolidation of plural business systems by displaying operations that may be consolidated from the use status of the batch processing result and the working state of the business systems regarding each time zone.

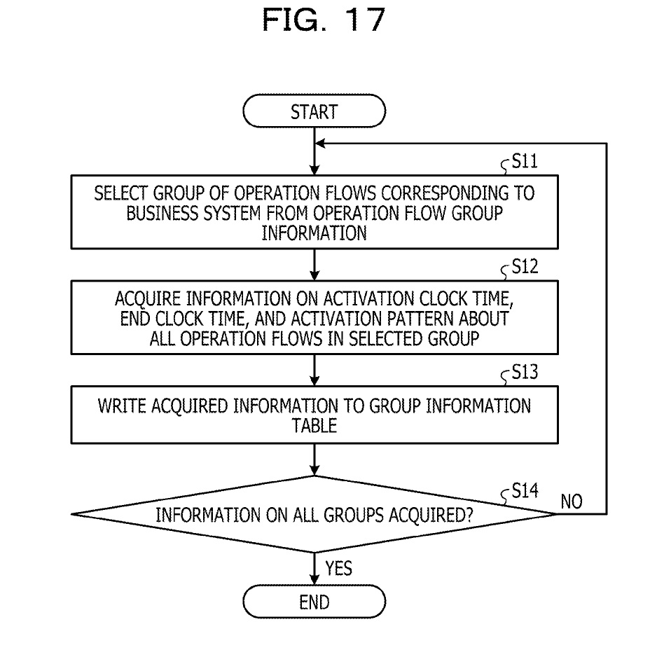

FIG. 17 is a flowchart illustrating a flow of processing of the step S1. As illustrated in FIG. 17, the acquiring unit 51a selects a group of operation flows corresponding to a business system from the operation flow group information (step S11). Then, the acquiring unit 51a acquires information on the activation clock time, the end clock time, and the activation pattern about all operation flows in the selected group (step S12).

Then, the acquiring unit 51a writes the acquired information to the group information table (step S13) and determines whether or not information on all groups has been acquired (step S14). Then, the acquiring unit 51a returns to the step S11 if a group from which information has not been acquired exists, and ends the processing if a group from which information has not been acquired does not exist.

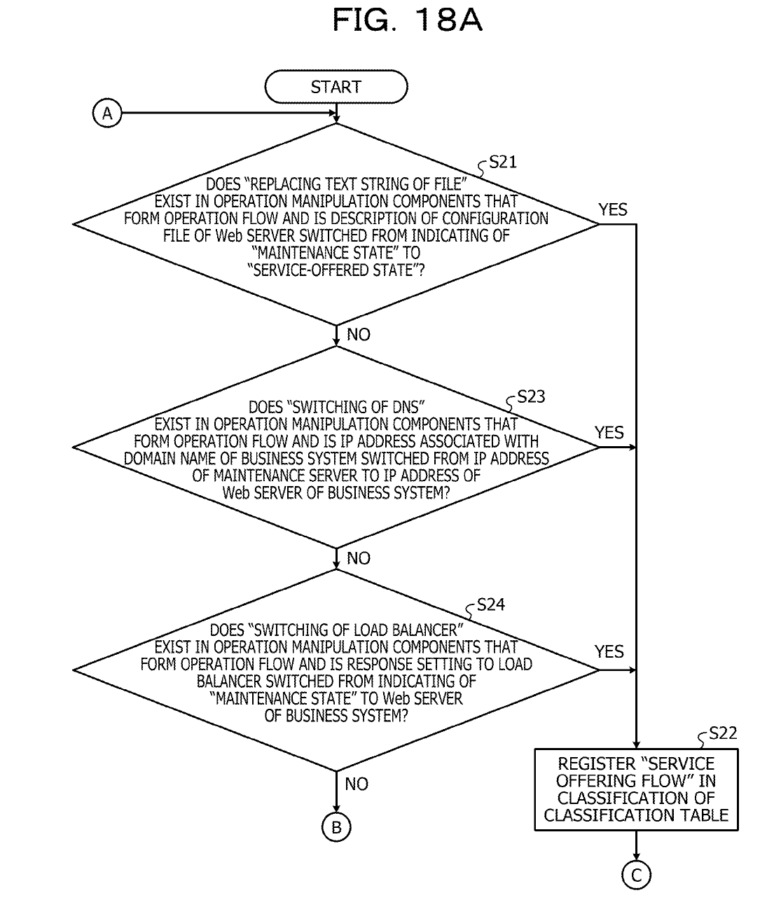

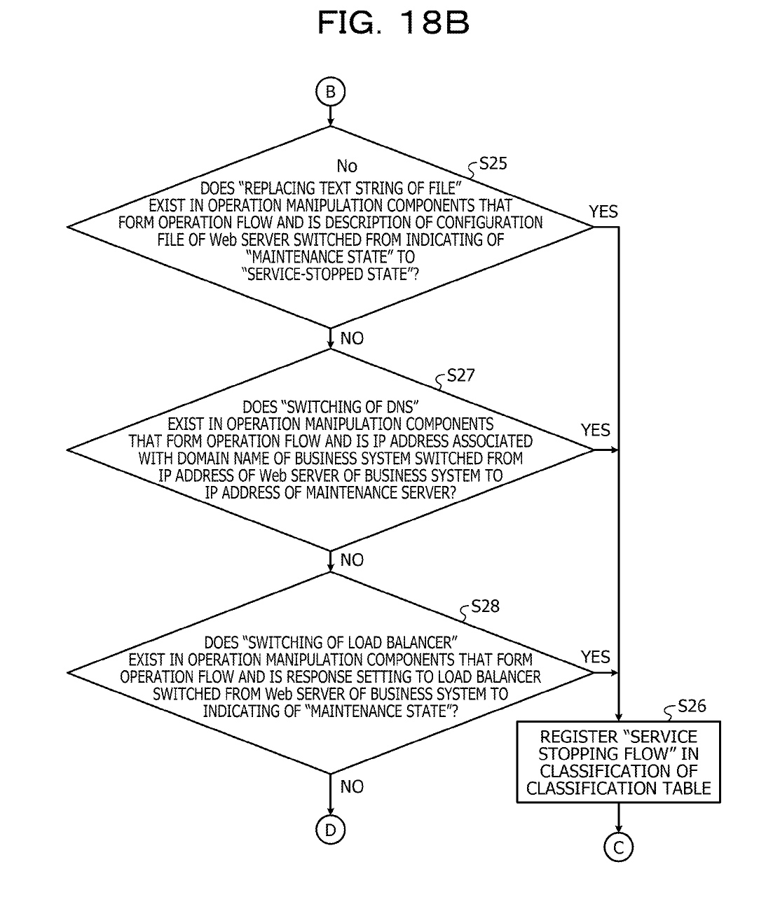

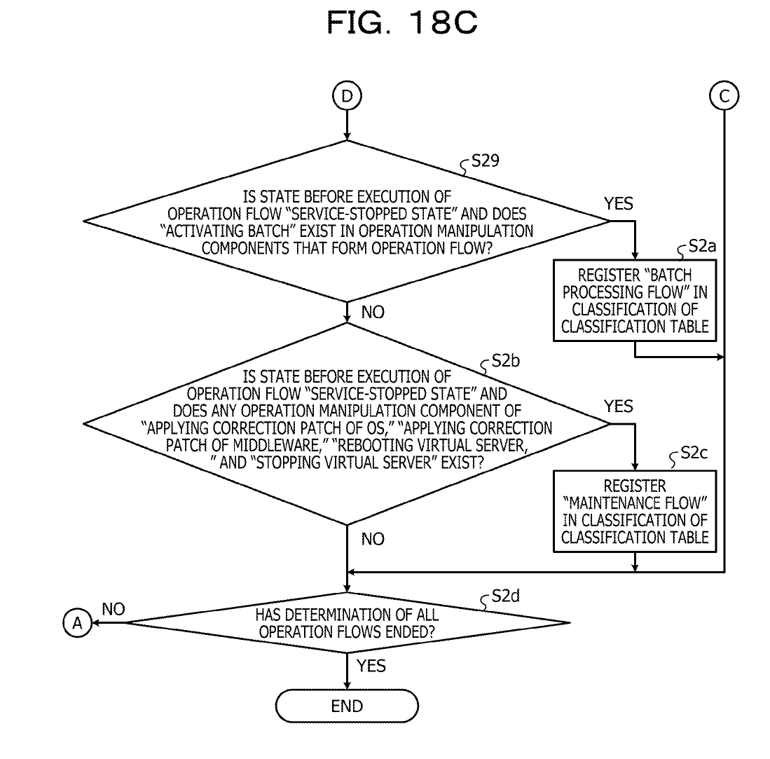

FIGS. 18A, 18B and 18C are a flowchart illustrating a flow of processing of the step S2. As illustrated in FIGS. 18A, 18B and 18C, the classifying unit 51b determines whether or not “replacing text string of file” exists in the operation manipulation components that form the operation flow and the description of the configuration file of the Web server is switched from indicating of the “maintenance state” to the “service-offered state” (step S21). Then, if the determination result of the step S21 is “Yes,” the classifying unit 51b registers the “service offering flow” in the classification of the classification table (step S22) and proceeds to a step Std.

On the other hand, if the determination result of the step S21 is “No,” the classifying unit 51b determines whether or not “switching of DNS” exists in the operation manipulation components that form the operation flow and the IP address associated with the domain name of the business system is switched from the IP address of the maintenance server to the IP address of the Web server of the business system (step S23). Then, if the determination result of the step S23 is “Yes,” the classifying unit 51b registers the “service offering flow” in the classification of the classification table (step S22) and proceeds to the step Std.

On the other hand, if the determination result of the step S23 is “No,” the classifying unit 51b determines whether or not “switching of load balancer” exists in the operation manipulation components that form the operation flow and the response setting to the load balancer is switched from indicating of the “maintenance state” to the Web server of the business system (step S24). Then, if the determination result of the step S24 is “Yes,” the classifying unit 51b registers the “service offering flow” in the classification of the classification table (step S22) and proceeds to the step S2d.

On the other hand, if the determination result of the step S24 is “No,” the classifying unit 51b determines whether or not “replacing text string of file” exists in the operation manipulation components that form the operation flow and the description of the configuration file of the Web server is switched from indicating of the “maintenance state” to the “service-stopped state” (step S25). Then, if the determination result of the step S25 is “Yes,” the classifying unit 51b registers the “service stopping flow” in the classification of the classification table (step S26) and proceeds to the step S2d.

On the other hand, if the determination result of the step S25 is “No,” the classifying unit 51b determines whether or not “switching of DNS” exists in the operation manipulation components that form the operation flow and the IP address associated with the domain name of the business system is switched from the IP address of the Web server of the business system to the IP address of the maintenance server (step S27). Then, if the determination result of the step S27 is “Yes,” the classifying unit 51b registers the “service stopping flow” in the classification of the classification table (step S26) and proceeds to the step S2d.

On the other hand, if the determination result of the step S27 is “No,” the classifying unit 51b determines whether or not “switching of load balancer” exists in the operation manipulation components that form the operation flow and the response setting to the load balancer is switched from the Web server of the business system to indicating of the “maintenance state” (step S28). Then, if the determination result of the step S28 is “Yes,” the classifying unit 51b registers the “service stopping flow” in the classification of the classification table (step S26) and proceeds to the step S2d.

On the other hand, if the determination result of the step S28 is “No,” the classifying unit 51b determines whether or not the state before execution of the operation flow is the “service-stopped state” and “activating batch” exists in the operation manipulation components that form the operation flow (step S29). Then, if the determination result of the step S29 is “Yes,” the classifying unit 51b registers the “batch processing flow” in the classification of the classification table (step S2a) and proceeds to the step S2d.

On the other hand, if the determination result of the step S29 is “No,” the classifying unit 51b determines whether or not the state before execution of the operation flow is the “service-stopped state” and any operation manipulation component of “applying correction patch of OS,” “applying correction patch of middleware,” “rebooting virtual server,” and “stopping virtual server” exists (step S2b). Then, if the determination result of the step S2b is “Yes,” the classifying unit 51b registers the “maintenance flow” in the classification of the classification table (step S2c).

Then, the classifying unit 51b determines whether or not determination of all operation flows has ended (step S2d). The classifying unit 51b returns to the step S21 if an operation flow that has not been determined exists, and ends the processing if determination of all operation flows has ended.

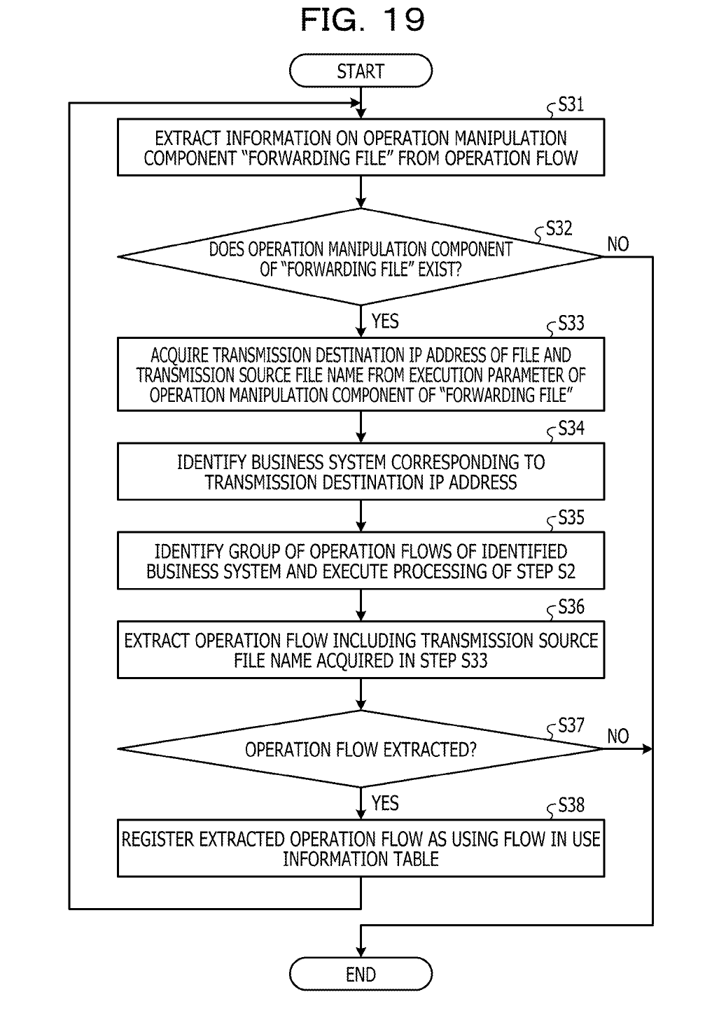

FIG. 19 is a flowchart illustrating a flow of processing of the step S3. As illustrated in FIG. 19, the use status identifying unit 52 extracts information on the operation manipulation component “forwarding file” from the operation flow (step S31) and determines whether or not the operation manipulation component of “forwarding file” exists (step S32). Then, if the operation manipulation component of “forwarding file” does not exist, the use status identifying unit 52 ends the processing.

On the other hand, if the operation manipulation component of “forwarding file” exists, the use status identifying unit 52 acquires the transmission destination IP address of the file and the transmission source file name from the execution parameter of the operation manipulation component of “forwarding file” (step S33). Then, the use status identifying unit 52 identifies the business system corresponding to the transmission destination IP address (step S34).

Then, the use status identifying unit 52 identifies the group of the identified business system and executes the processing of the step S2 (step S35). Then, the use status identifying unit 52 extracts an operation flow including the transmission source file name acquired in the step S33 (step S36) and determines whether or not an operation flow has been extracted (step S37). Then, if an operation flow has not been extracted, the use status identifying unit 52 ends the processing.

On the other hand, if an operation flow has been extracted, the use status identifying unit 52 registers the extracted operation flow in the use information table as the using flow (step S38) and returns to the step S31.

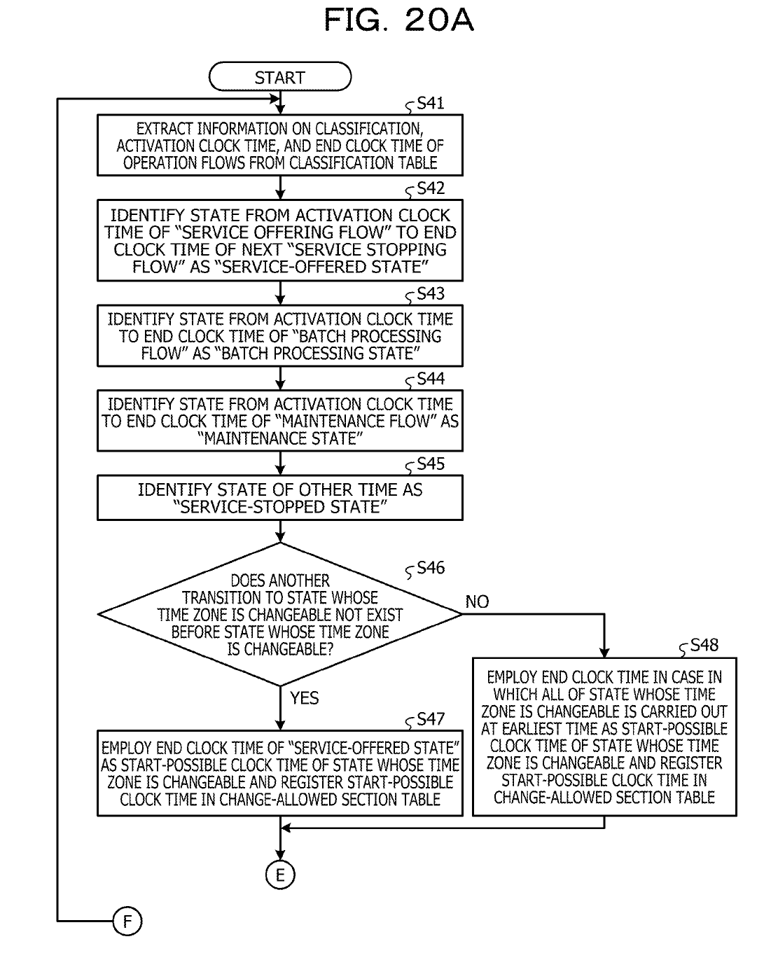

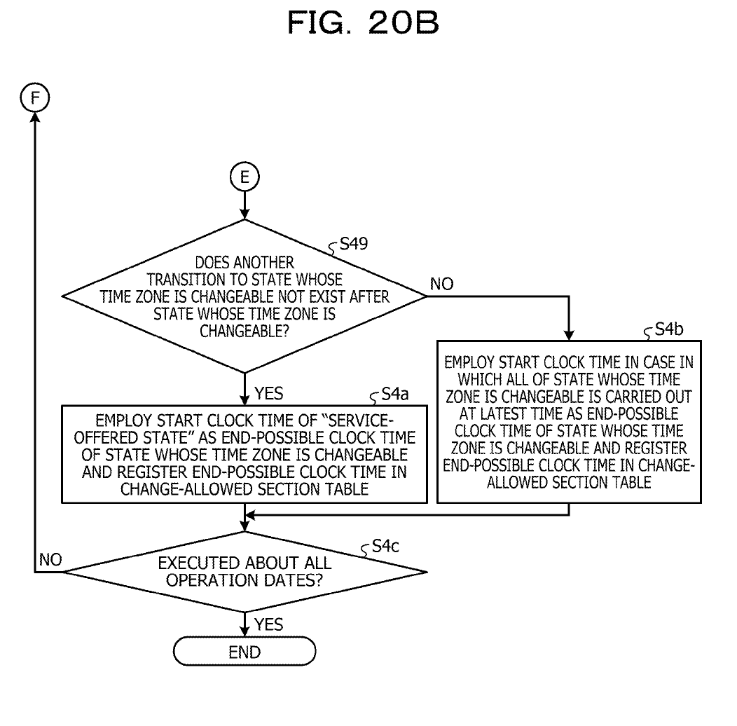

FIGS. 20A and 20B are a flowchart illustrating a flow of processing of the step S4. As illustrated in FIGS. 20A and 20B, the schedule identifying unit 53 extracts information on the classification, the activation clock time, and the end clock time of the operation flows from the classification table (step S41). Then, the schedule identifying unit 53 identifies the state from the activation clock time of the “service offering flow” to the end clock time of the next “service stopping flow” as the “service-offered state” (step S42).

Then, the schedule identifying unit 53 identifies the state from the activation clock time to the end clock time of the “batch processing flow” as the “batch processing state” (step S43) and identifies the state from the activation clock time to the end clock time of the “maintenance flow” as the “maintenance state” (step S44). Then, the schedule identifying unit 53 identifies the state of the other time as the “service-stopped state” (step S45).

Then, the schedule identifying unit 53 determines whether or not another transition to the state whose time zone is changeable does not exist before the state whose time zone is changeable (step S46). Then, if the determination result of the step S46 is “Yes,” the schedule identifying unit 53 employs the end clock time of the “service-offered state” as the start-possible clock time of the state whose time zone is changeable and registers the start-possible clock time in the change-allowed section table (step S47). On the other hand, if the determination result of the step S46 is “No,” the schedule identifying unit 53 employs the end clock time in the case in which all of the state whose time zone is changeable is carried out at the earliest time as the start-possible clock time of the state whose time zone is changeable and registers the start-possible clock time in the change-allowed section table (step S48). When identifying the start-possible clock time of the state whose time zone is changeable, the schedule identifying unit 53 uses the use status of the batch processing result as a constraint.

Then, the schedule identifying unit 53 determines whether or not another transition to the state whose time zone is changeable does not exist after the state whose time zone is changeable (step S49). Then, if the determination result of the step S49 is “Yes,” the schedule identifying unit 53 employs the start clock time of the “service-offered state” as the end-possible clock time of the state whose time zone is changeable and registers the end-possible clock time in the change-allowed section table (step S4a). On the other hand, if the determination result of the step S49 is “No,” the schedule identifying unit 53 employs the start clock time in the case in which all of the state whose time zone is changeable is carried out at the latest time as the end-possible clock time of the state whose time zone is changeable and registers the end-possible clock time in the change-allowed section table (step S4b). When identifying the end-possible clock time of the state whose time zone is changeable, the schedule identifying unit 53 uses the use status of the batch processing result as a constraint.

Then, the schedule identifying unit 53 determines whether or not the processing has been executed about all operation dates (step S4c). The schedule identifying unit 53 returns to the step S41 if an operation date about which the processing has not been executed exists, and ends the processing if the processing has been executed about all operation dates.

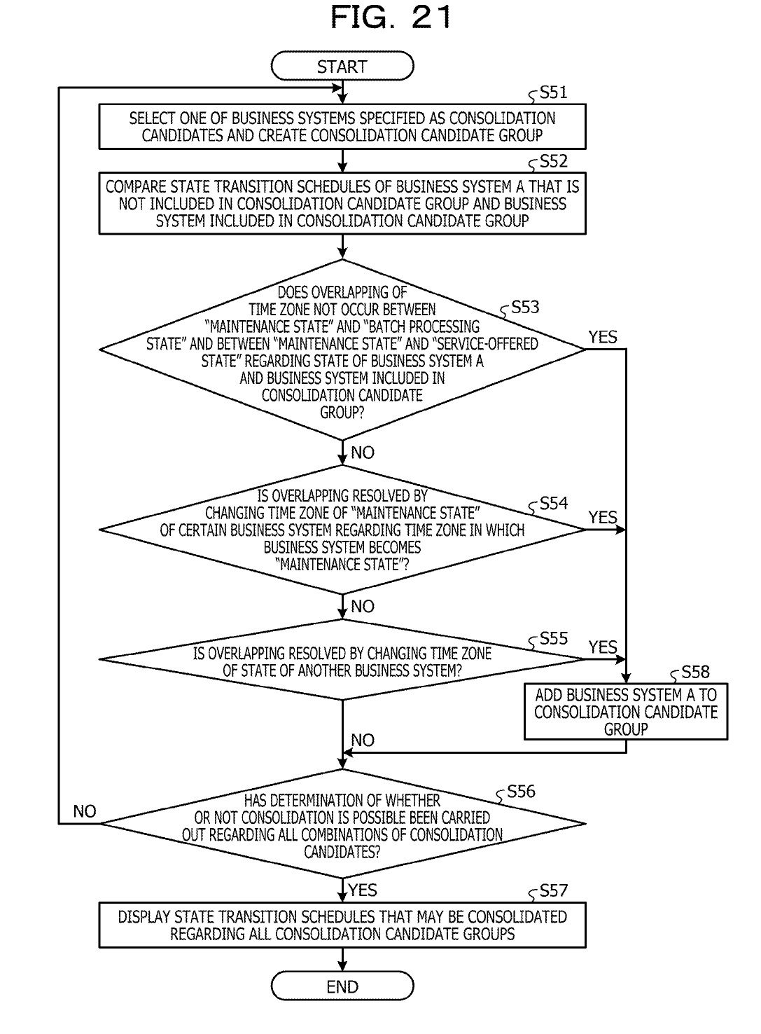

FIG. 21 is a flowchart illustrating a flow of processing of the step S5. As illustrated in FIG. 21, the consolidating unit 54 selects one of the business systems specified as the consolidation candidates and creates a consolidation candidate group (step S51). Then, the consolidating unit 54 compares the state transition schedules of business system A that is not included in the consolidation candidate group and the business system included in the consolidation candidate group (step S52).

Then, the consolidating unit 54 determines whether or not overlapping of the time zone does not occur between the “maintenance state” and the “batch processing state” and between the “maintenance state” and the “service-offered state” regarding the state of business system A and the business system included in the consolidation candidate group (step S53).

Then, if the determination result of the step S53 is “No,” the consolidating unit 54 determines whether or not the overlapping is resolved by changing the time zone of the “maintenance state” of a certain business system regarding the time zone in which the business system becomes the “maintenance state” (step S54). Then, if the determination result of the step S54 is “No,” the consolidating unit 54 determines whether or not the overlapping is resolved by changing the time zone of a state of another business system (step S55).

Then, if the determination result of the step S55 is “No,” the consolidating unit 54 determines whether or not the determination of whether or not consolidation is possible has been carried out regarding all combinations of the consolidation candidates (step S56). If a combination regarding which the determination of whether or not consolidation is possible has not been carried out exists, the consolidating unit 54 returns to the step S51. On the other hand, if the determination of whether or not consolidation is possible has been carried out regarding all combinations of the consolidation candidates, the consolidating unit 54 displays the state transition schedules that may be consolidated regarding all consolidation candidate groups (step S57).

Furthermore, if the determination result of the step S53, the step S54, and the step S55 is “Yes,” the consolidating unit 54 adds business system A to the consolidation candidate group (step S58) and moves to the step S56.

As described above, in the embodiment, the classifying unit 51b of the consolidation support unit 5 classifies each operation flow based on the contents of the operation manipulation components included in plural operation flows corresponding to a respective one of plural business systems that are specified. Then, the schedule identifying unit 53 identifies the working states of the business systems and the period and change-allowed period of each working state based on the classification, the activation clock time, and the end clock time of the operation flows. Then, the determining unit 54a determines whether or not it is possible to generate a combination of plural business systems in which working states that are impossible to be simultaneously taken among the plural business systems do not occur by changing the working state in the range of the change-allowed period. Then, if a combination of plural business systems in which working states that are impossible to be simultaneously taken among the plural business systems do not occur is generated, the output unit 54b displays the combination of plural business systems and the periods after the change in the working state. Therefore, the consolidation support unit 5 may support consolidation of the plural business systems.

Furthermore, in the embodiment, the use status identifying unit 52 identifies the status in which a batch processing result is used in batch processing of another business system, and the schedule identifying unit 53 identifies the change-allowed period of the working state in such a manner that the batch processing result may be used in the batch processing of the other business system. Therefore, the consolidation support unit 5 may display a consolidation plan with which the batch processing result may be used in the batch processing of the other business system.

Moreover, in the embodiment, the use status identifying unit 52 identifies the name of the file that stores a batch processing result from the operation manipulation component information of a batch processing flow and determines whether the name of the file is included in the operation manipulation component information of a batch processing flow of the business system of the forwarding destination of the batch processing result. Then, if the name of the file is included in the operation manipulation component information of a batch processing flow of the business system of the transmission destination of the batch processing result, the use status identifying unit 52 determines that the batch processing result is used in batch processing of another business system. Therefore, the use status identifying unit 52 may accurately identify the status in which the batch processing result is used in batch processing of another business system.

In addition, in the embodiment, if a manipulation that represents the end of maintenance and activation of a service exists in the operation manipulation components included in an operation flow, the classifying unit 51b identifies this operation flow as the “service offering flow.” Furthermore, if a manipulation that represents the end of maintenance and stop of a service exists in the operation manipulation components included in an operation flow, the classifying unit 51b identifies this operation flow as the “service stopping flow.” Moreover, if the state before execution of an operation flow is the “service-stopped state” and a manipulation that represents activation of batch processing exists in the operation manipulation components included in the operation flow, the classifying unit 51b identifies this operation flow as the “batch processing flow.” In addition, if the state before execution of an operation flow is the “service-stopped state” and a manipulation that represents maintenance work exists in the operation manipulation components included in the operation flow, the classifying unit 51b identifies this operation flow as the “maintenance flow.” Therefore, the classifying unit 51b may accurately classify the operation flows.

Furthermore, in the embodiment, the schedule identifying unit 53 may accurately identify the working states of the business systems because identifying the working states of the business systems based on the type, the activation clock time, and the end clock time of the operation flows.

Moreover, in the embodiment, the determining unit 54a determines whether or not consolidation is possible while deeming the “maintenance state” and the “service-offered state” as states that are impossible to be simultaneously taken and deeming the “maintenance state” and the “batch processing state” as states that are impossible to be simultaneously taken. Therefore, the determining unit 54a may suppress the occurrence of the situation in which processing is executed in maintenance due to consolidation.

In the embodiment, explanation is made about the consolidation support unit 5. However, a consolidation support program having similar functions may be obtained by implementing configurations possessed by the consolidation support unit 5 by software. Therefore, a computer that executes the consolidation support program will be described.

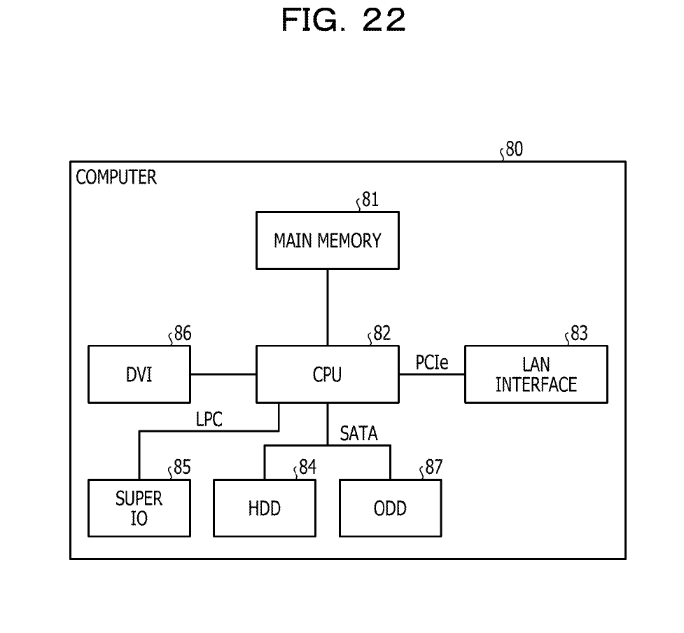

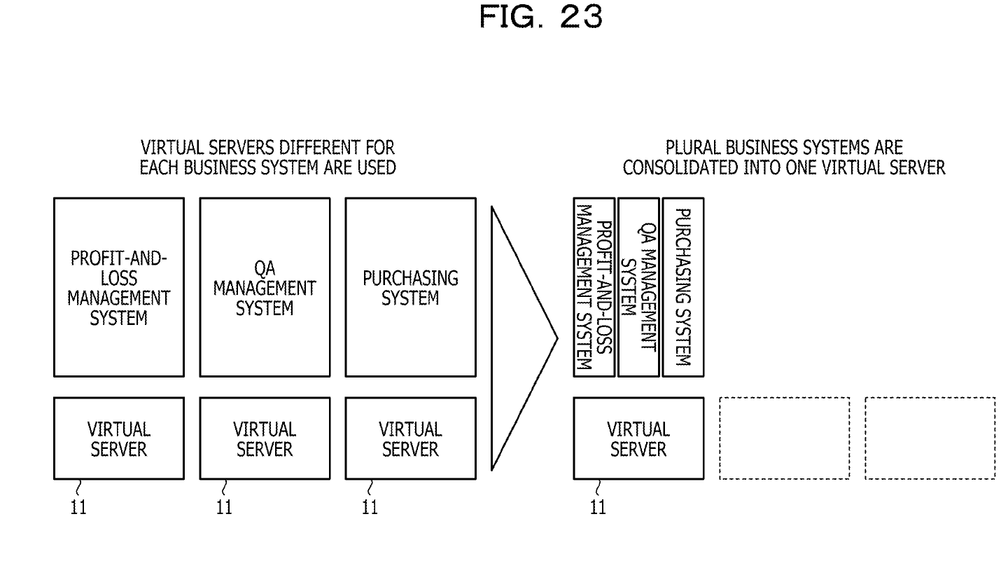

FIG. 22 is a diagram illustrating a hardware configuration of a computer that executes a consolidation support program according to the embodiment. As illustrated in FIG. 22, a computer 80 includes a main memory 81, a central processing unit (CPU) 82, a local area network (LAN) interface 83, and a hard disk drive (HDD) 84. Furthermore, the computer 80 includes a super input-output (IO) 85, a digital visual interface (DVI) 86, and an optical disk drive (ODD) 87.

The main memory 81 is a memory that stores a program, a result in the middle of execution of a program, and so forth. The CPU 82 is a central processing device that reads out a program from the main memory 81 and executes the program. The CPU 82 includes a chipset including a memory controller.

The LAN interface 83 is an interface for coupling the computer 80 to another computer via a LAN. The HDD 84 is a disk device that stores programs and data and the super IO 85 is an interface for coupling input devices such as a mouse and a keyboard. The DVI 86 is an interface to which a liquid crystal display device is coupled and the ODD 87 is a device that carries out reading and writing of a digital versatile disc (DVD).

The LAN interface 83 is coupled to the CPU 82 by peripheral component interconnect (PCI)-express (PCIe) and the HDD 84 and the ODD 87 are coupled to the CPU 82 by serial advanced technology attachment (SATA). The super IO 85 is coupled to the CPU 82 by low pin count (LPC).

Furthermore, the consolidation support program executed in the computer 80 is stored in a DVD and is read out from the DVD by the ODD 87 to be installed on the computer 80. Alternatively, the consolidation support program is stored in a database or the like of another computer system coupled through the LAN interface 83 and is read out from this database to be installed on the computer 80. Then, the installed consolidation support program is stored in the HDD 84 and is read out to the main memory 81 to be executed by the CPU 82.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a consolidation support program that causes a computer to execute a process, the process comprising:
retrieving, from a storage device, business system information for a plurality of business systems configured to execute on a plurality of virtual servers, each of the plurality of business systems includes operation flows that define a plurality of operation manipulations that operate business system;
classifying, for each of the plurality of business systems, the operation flows into operation flow types based on the operation manipulations of each of the operation flows;
identifying working states of the plurality of business systems and an execution period and a change-allowed period of each of the working states based on the identified operation flow type and a start clock time and an end clock time of each of the operation flows;
generating, based on the working states of the plurality of business systems and the execution period and the change-allowed period of each of the working states, a state transition schedule for the plurality of business systems;
changing, in accordance with the state transition schedule, the execution period of a first working state of a first business system included in the plurality of business systems in a range of the change-allowed period to prevent an overlapping of the execution period of the first working state with the execution period of a second working state of a second business system included in the plurality of business systems, the first working state and the second working state being unable to be executed simultaneously on a single virtual server; and
outputting the state transition schedule including the changed execution period of the first working state.

2. The non-transitory computer-readable storage medium according to claim 1, further comprising:
executing, based on the changed execution period of the first working state, the plurality of business systems on a single virtual server.

3. The non-transitory computer-readable storage medium according to claim 1, wherein the identifying further comprises
identifying the change-allowed period such that activation of the second batch processing before completion of the first batch processing does not occur when the first working state is a first batch processing of the first business system that produces a batch result used by the second working state which is a second batch processing of a second business system.

4. The non-transitory computer-readable storage medium according to claim 1, wherein
the classifying includes:
identifying an operation flow as a service offering flow when an operation manipulation that represents end of maintenance and offering of a service exists in operation manipulations included in the operation flow;
identifying the operation flow as a service stopping flow when an operation manipulation that represents end of maintenance and stop of a service exists in operation manipulations included in the operation flow;
identifying the operation flow as a batch processing flow when a state before execution of the operation flow is a service-stopped state and an operation manipulation that represents activation of batch processing exists in operation manipulations included in the operation flow; and
identifying the operation flow as a maintenance flow when a state before execution of the operation flow is a service-stopped state and an operation manipulation that represents maintenance work exists in operation manipulations included in the operation flow.

5. The non-transitory computer-readable storage medium according to claim 4, wherein the identifying further includes:
identifying a working state of a business system from an activation clock time of the service offering flow to an end clock time of the next service stopping flow as a service-offered state;
identifying a working state of a business system from an activation clock time to an end clock time of the batch processing flow as a batch processing state;
identifying a working state of a business system from an activation clock time to an end clock time of the maintenance flow as a maintenance state; and
identifying a working state of a business system in a time zone during which the working state is none of the service-offered state, the batch processing state, and the maintenance state as a service-stopped state.

6. The non-transitory computer-readable storage medium according to claim 5, wherein
the maintenance state and the service-offered state are working states that are unable to be executed simultaneously on a single virtual server, and
the maintenance state and the batch processing state are working states that are unable to be executed simultaneously on a single virtual server.

7. A consolidation support method in which a computer executes processing comprising:
retrieving, from a storage device, business system information for a plurality of business systems configured to execute on a plurality of virtual servers, each of the plurality of business systems includes operation flows that define a plurality of operation manipulations that operate business system;
classifying, for each of the plurality of business systems, the operation flows into operation flow types based on the operation manipulations of each of the operation flows;
identifying working states of the plurality of business systems and an execution period and a change-allowed period of each of the working states based on the identified operation flow type and a start clock time and an end clock time of each of the operation flows;
generating, based on the working states of the plurality of business systems and the execution period and the change-allowed period of each of the working states, a state transition schedule for the plurality of business systems;
changing, in accordance with the state transition schedule, the execution period of a first working state of a first business system included in the plurality of business systems in a range of the change-allowed period to prevent an overlapping of the execution period of the first working state with the execution period of a second working state of a second business system included in the plurality of business systems, the first working state and the second working state being unable to be executed simultaneously on a single virtual server; and
outputting the state transition schedule including the changed execution period of the first working state.

8. The consolidation support method according to claim 7, further comprising:
executing, based on the changed execution period of the first working state, the plurality of business systems on a single virtual server.

9. A consolidation support device comprising:
a memory; and
a processor coupled to the memory and the processor configured to execute the process, the process including:
retrieving, from a storage device, business system information for a plurality of business systems configured to execute on a plurality of virtual servers, each of the plurality of business systems includes operation flows that define a plurality of operation manipulations that operate business system;
classifying, for each of the plurality of business systems, the operation flows into operation flow types based on the operation manipulations of each of the operation flows;
identifying working states of the plurality of business systems and an execution period and a change-allowed period of each of the working states based on the identified operation flow type and a start clock time and an end clock time of each of the operation flows;
generating, based on the working states of the plurality of business systems and the execution period and the change-allowed period of each working states, a state transition schedule for the plurality of business systems;
changing, in accordance with the state transition schedule, the execution period of a first working state of a first business system included in the plurality of business systems in a range of the change-allowed period to prevent an overlapping of the execution period of the first working state with the execution period of a second working state of a second business system included in the plurality of business systems, the first working state and the second working state being unable to be executed simultaneously on a single virtual server; and
outputting the state transition schedule including the changed execution period of the first working state

10. The consolidation support device according to claim 9, further comprising:
executing, based on the changed execution period of the first working state, the plurality of business systems on a single virtual server.
